(19) United States
(12) Patent Application Publication
(10) Pub. No.: US 2026/0342945 A1
(43) Pub. Date: Oct. 29, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TSUYOSHI YABUKANE, Tokyo (JP)

(21) Appl. No.: 19/654,960

(22) Filed: Apr. 22, 2026

(30) Foreign Application Priority Data
Apr. 28, 2025 (JP) 2025-074997

(51) Int. Cl. H04N 7/18; H04N 23/611; H04N 23/695; H04N 23/90

(52) U.S. Cl. CPC H04N 7/181; H04N 23/611; H04N 23/695; H04N 23/90

(57) ABSTRACT

An information processing apparatus receives video images captured by a plurality of cameras rotatable in at least two directions, calculates an occupancy rate of a subject relative to the received video images, calculate a frontality of the subject in the received video images, selects a video image from the received video images based on the occupancy rate in a case where the occupancy rates of all of the received video images are smaller than or equal to a threshold a threshold, selects a video image from video images having the occupancy rates exceeding a threshold based on the frontality in a case where the occupancy rate relative to any video image out of the received video images exceeds the threshold, and outputs the selected video image.

### BACKGROUND

### Field of the Technology

The present disclosure relates to an information processing apparatus.

### Description of the Related Art

A plurality of pan-tilt-zoom (PTZ) cameras may be operated by a remote camera controller to capture images. Japanese Patent Laid-Open No. 2004-128646 describes a system that performs control such that a predetermined camera out of a plurality of PTZ cameras captures an image of a target subject.

In the technique described in Japanese Patent Laid-Open No. 2004-128646, an instruction from a user is needed in the selection of the camera used to capture an image of the target subject. Consequently, such a technique imposes a selection burden on the user.

### SUMMARY

The present disclosure is directed to a technique that can reduce a selection burden on a user.

According to an aspect of the present disclosure, an information processing apparatus receives video images captured by a plurality of cameras rotatable in at least two directions, calculate an occupancy rate of a subject relative to the received video images, calculates a frontality of the subject in the received video images, selects a video image from the received video images based on the occupancy rate in a case where the occupancy rates of all of the received video images are smaller than or equal to a threshold, selects a video image from video images having the occupancy rates exceeding a threshold based on the frontality in a case where the occupancy rate relative to any video image out of the received video images exceeds the threshold, and outputs the selected video image.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a schematic configuration of a remote camera system according to a first embodiment.

FIG. 2 is a functional block diagram illustrating an example of functions of an information processing apparatus according to the first embodiment.

FIG. 3 is a flowchart illustrating camera selection processing according to the first embodiment.

FIGS. 4A-4G illustrate video images captured by a pant-tilt-zoom (PTZ) camera.

FIG. 5 is a flowchart illustrating camera selection processing according to a second embodiment.

FIGS. 6A-6D illustrates a video image captured by a PTZ cameras 120a-120d, respectively.

FIG. 7 is a diagram illustrating an example of a hardware configuration of the information processing apparatus according to the first embodiment.

### DESCRIPTION OF THE EMBODIMENTS

Hereinafter, embodiments of the present disclosure are described with reference to the drawings. Each of the embodiments is merely one example to describe a technical concept of the present disclosure, and the present disclosure is not intended to be limited to the configuration and the method described in each embodiment. While a plurality of aspects is described in the embodiments, not all are necessarily required for the present disclosure, and these aspects may be optionally combined. In the drawings, the same or similar configurations are given the same reference numerals, and redundant descriptions are omitted.

In the following description, a pan-tilt-zoom (PTZ) camera represents a camera having pan, tilt, and zoom functions. More particularly, the PTZ camera is rotatable in a pan direction and a tilt direction, and has a viewing angle that can be changed by driving a zoom lens. The PTZ camera may be removably attached to a panhead. In such a case, the PTZ camera is rotatable in a pan direction and a tilt direction by the panhead. Alternatively, the PTZ camera may be attached to a panhead in a state in which the camera is not removable from the panhead. The PTZ camera is remotely operated for pan-direction control, tilt-direction control, and zoom control. Moreover, the present disclosure can be applied to a case where a camera that is rotatable in at least two directions is used. In such a case, rotatable directions of the camera are not limited to a pan direction and a tilt direction. The two directions can be a first direction and a second direction intersecting the first direction.

### First Embodiment

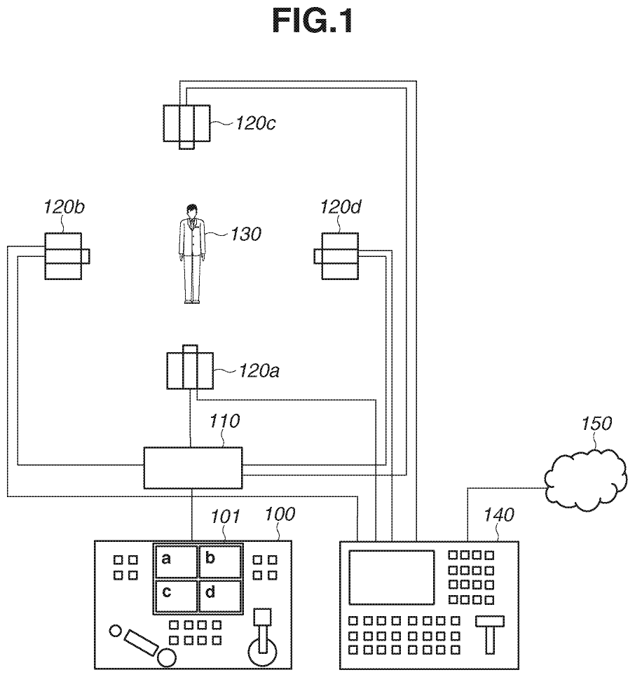

FIG. 1 is a block diagram illustrating a schematic configuration of a remote camera system according to the present embodiment. The remote camera system illustrated in FIG. 1 includes a remote camera controller 100, a plurality of PTZ cameras 120a through 120d, and a switcher (an information processing apparatus) 140. The remote camera system can include a switching hub 110 and a distribution server 150. The remote camera system can include a camera other than the PTZ camera. That is, the remote camera system can include a camera the image capturing direction of which is not changed when an image is captured. Moreover, the remote camera system can include a device such as a microphone other than the camera. In the remote camera system illustrated in FIG. 1, the PTZ cameras 120a through 120d for capturing a subject 130 are connected to the remote camera controller 100, so that the PTZ cameras 120a through 120d can be remotely operated. As illustrated in FIG. 1, four PTZ cameras are placed such that the subject 130 is surrounded on all sides by the four cameras. However, the number of cameras is not limited to four. The number of cameras can be three or less or five or more.

The PTZ cameras 120a through 120d and the remote camera controller 100 are connected by a local area network (LAN) cable and the switching hub 110 for LAN. The remote camera controller 100 includes a display panel 101 on which video images captured by the respective PTZ cameras 120a through 120d can be checked, and various operation members such as a dial, a joystick, and a zoom seesaw that can remotely operate the PTZ cameras 120a through 120d.

Moreover, the connection of the PTZ cameras 120a through 120d to the switcher 140 enables the switcher 140 to select a video image captured by the PTZ camera. The PTZ cameras 120a through 120d and the remote camera controller 100 can be connected using a serial digital interface (SDI) cable or a high-definition multimedia interface (HDMI) (registered trademark) cable.

The captured video image selected by the switcher 140 can be distributed to a viewer by the distribution server 150 connected to the switcher 140. The distribution server 150 represents a computer that distributes information on the Internet.

The methods for connecting the remote camera controller 100, the PTZ cameras 120a through 120d, and the switcher 140, the installation positions of the PTZ cameras 120a through 120d, and the number of PTZ cameras are not limited to those described in the present embodiment, and various modifications and changes can be made within the scope of the present disclosure.

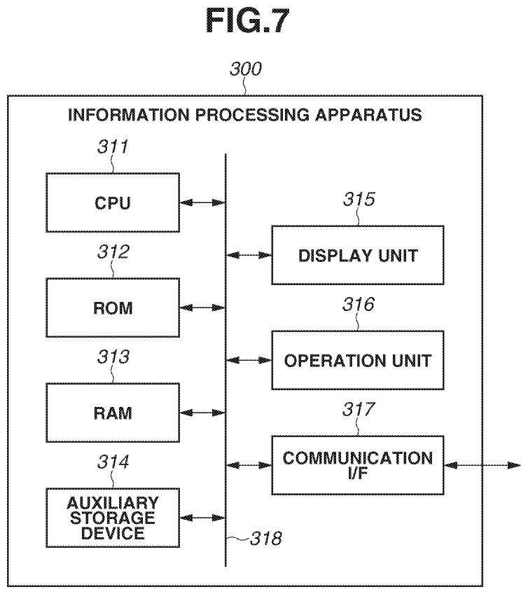

A hardware configuration of an information processing apparatus 300 as a switcher is described with reference to FIG. 7. The information processing apparatus 300 includes a central processing unit (CPU) 311, a read only memory (ROM) 312, a random access memory (RAM) 313, an auxiliary storage device 314, a display unit 315, an operation unit 316, a communication interface (I/F) 317, and a bus 318.

The CPU 311 comprehensively controls the information processing apparatus 300 by using a computer program or data stored in the ROM 312 or the RAM 313, so that each function of the information processing apparatus 300 is provided. The information processing apparatus 300 may include one or a plurality of pieces of dedicated hardware different from the CPU 311. In such a case, the dedicated hardware can execute at least one portion of the processing performed by the CPU 311. Examples of the dedicated hardware include an application specific integrated circuit (ASIC), a field programmable gate array (FPGA), and a digital signal processor (DSP). The ROM 312 stores, for example, a program that does not require a change. The RAM 313 temporarily stores, for example, a program and data supplied from the auxiliary storage device 314, and data supplied from an external unit via the communication I/F 317. The auxiliary storage device 314 includes, for example, a hard disk drive, and stores various data such as image data and audio data.

The display unit 315 includes, for example, a liquid crystal display and a light emitting diode (LED). The display unit 315 displays, for example, a graphical user interface (GUI) for a user to operate the information processing apparatus 300. The operation unit 316 includes, for example, a keyboard, a mouse, a joystick, and a touch panel. Upon receiving an operation from a user, the operation unit 316 inputs various instructions to the CPU 311. The CPU 311 operates as a display controller that controls the display unit 315 and as an operation controller that controls the operation unit 316.

The communication I/F 317 is used for communication between the information processing apparatus 300 and an external apparatus. For example, in a case where the information processing apparatus 300 is connected to an external apparatus by wire, a communication cable is connected to the communication I/F 317. In a case where the information processing apparatus 300 has a function of wirelessly communicating with an external apparatus, the communication I/F 317 includes an antenna. The bus 318 connects each of the units in the information processing apparatus 300 to transmit information.

In the present embodiment, the display unit 315 and the operation unit 316 are arranged inside the information processing apparatus 300. However, at least one of the display unit 315 and the operation unit 316 may be arranged as another apparatus outside the information processing apparatus 300.

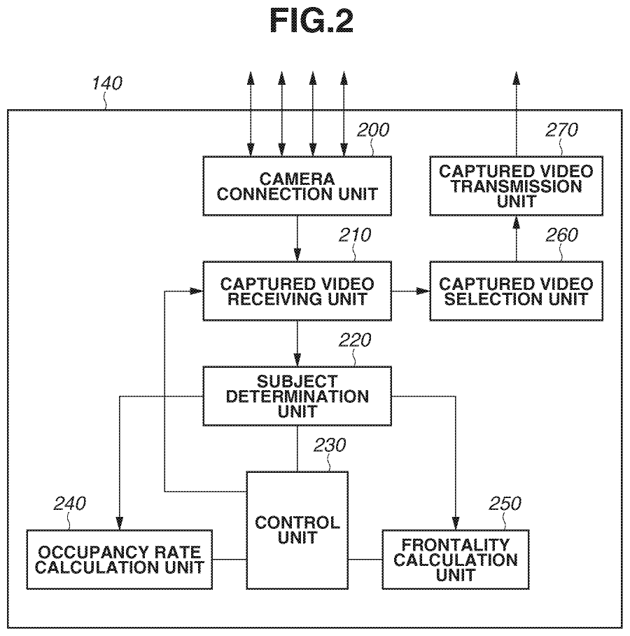

FIG. 2 is a functional block diagram of the switcher 140 according to the present embodiment of the present disclosure. A camera connection unit 200 connects the switcher 140 to the PTZ cameras 120a through 120d. For example, the camera connection unit 200 is an I/F connection unit such as SDI and HDMI. A captured video receiving unit 210 receives video images captured by the PTZ cameras 120a through 120d. A subject determination unit 220 determines whether video images of the same subject have been captured based on captured video data about the plurality of PTZ cameras 120a through 120d.

Based on the video images which have been captured by the respective PTZ cameras 120a through 120d and received by the captured video receiving unit 210, an occupancy rate calculation unit 240 calculates a subject occupancy rate of each of the video images. The subject occupancy rate represents, for example, a ratio of a subject to a viewing angle of a PTZ camera, or a ratio of a subject to a crop frame. An example of subject recognition includes a method for automatically recognizing/classifying a subject by using artificial intelligence (AI). The subject can be a moving object. The moving object can be a living thing such as a human and an animal, or a non-living thing such as a vehicle. That is, a subject occupancy rate can be a percentage of an area of a moving object that occupies a captured video image.

Based on the video images which have been captured by the respective PTZ cameras 120a through 120d and received by the captured video receiving unit 210, a frontality calculation unit 250 calculates a subject frontality of each of the captured video images. The subject frontality represents, for example, a degree to which a subject in a video image captured by a PTZ camera faces the front.

An example of subject frontality recognition includes a method for automatically recognizing a face or eyes of a human in a captured video image by using AI. The frontality calculation unit 250 calculates a degree to which the subject faces the front with respect to a viewing angle of the captured video image based on the recognized face or eyes of the human.

A captured video selection unit 260 selects any of the captured video images from the video images captured by the PTZ cameras 120a through 120d based on results of the calculations of the subject occupancy rate acquired by the occupancy rate calculation unit 240 and the subject frontality acquired by the frontality calculation unit 250. The captured video image selected by the captured video selection unit 260 is transmitted to the distribution server 150 via a captured video transmission unit 270, and then is distributed via the distribution server 150. For example, in LAN communication, the captured video transmission unit 270 converts a digital signal into an analog signal and outputs the analog signal by using an Ethernet PHY and an RJ45 connector with built-in pulse transformer.

A control unit 230 controls the captured video receiving unit 210, the subject determination unit 220, the occupancy rate calculation unit 240, the frontality calculation unit 250, the captured video selection unit 260, and the captured video transmission unit 270.

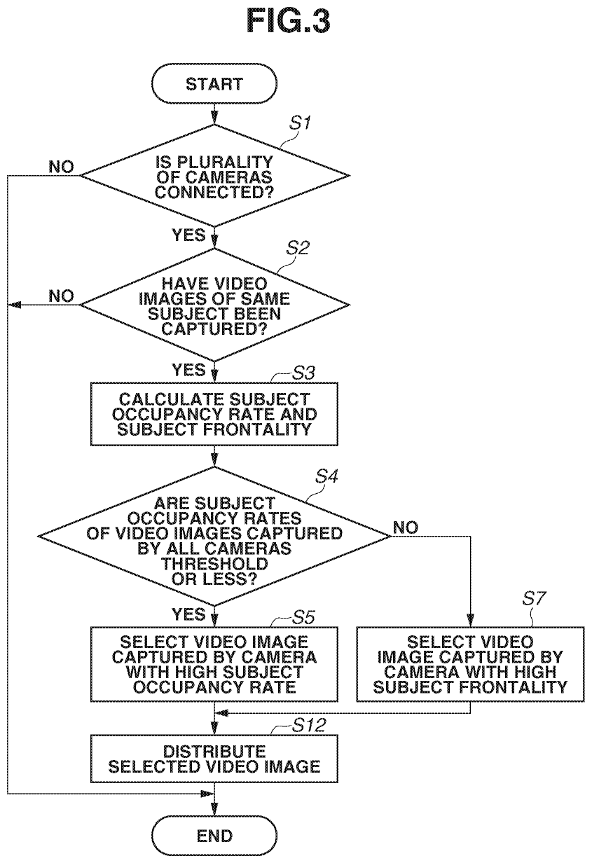

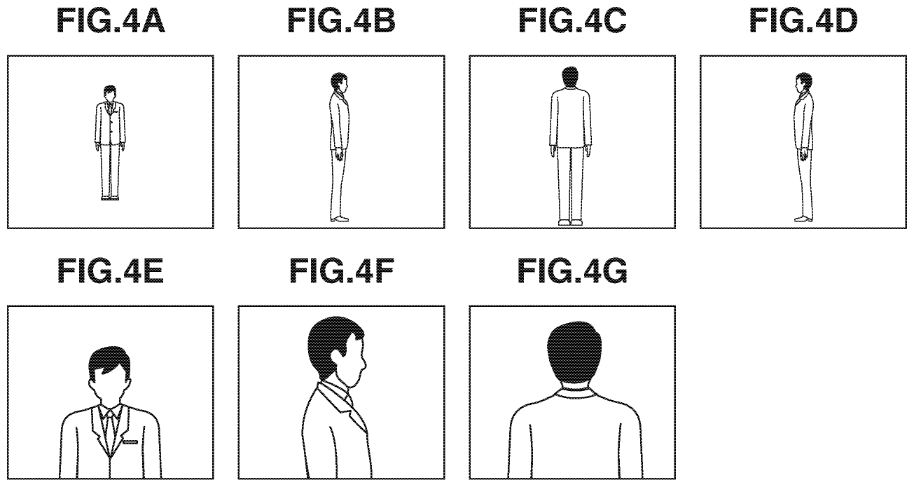

FIG. 3 is a flowchart illustrating camera selection processing according to the present embodiment. FIGS. 4A through 4G are diagrams illustrating a method for selecting a camera according to the present embodiment.

In step S1, upon activation, the switcher 140 checks whether a plurality of PTZ cameras 210 is connected to the camera connection unit 200. If a plurality of PTZ cameras 210 is connected to the camera connection unit 200 (YES in step S1), the processing proceeds to step S2. If a plurality of PTZ cameras 210 is not connected to the camera connection unit 200 (NO in step S1), the processing of the flowchart ends.

In step S2, the switcher 140 determines whether video images of the same subject have been captured based on captured video data about the plurality of PTZ cameras 120a through 120d. If video images of the same subjects have been captured by the PTZ cameras 120a through 120d (YES in step S2), the processing proceeds to step S3. If video images of the same subjects have not been captured by the PTZ cameras 120a through 120d (NO in step S2), the processing of the flowchart ends.

In step S3, the switcher 140 calculates a subject occupancy rate relative to the captured video data about each of the PTZ cameras 120. The switcher 140 also calculates a frontality of a subject in the captured video data about each of the PTZ cameras 120.

In step S4, the switcher 140 determines whether subject occupancy rates relative to the captured video data about all the PTZ cameras are smaller than or equal to a threshold. If subject occupancy rates relative to the captured video data about all the PTZ cameras are smaller than or equal to a threshold (YES in step S4), the processing proceeds to step S5. In step S5, from the captured video data about the respective PTZ cameras, the switcher 140 selects a video image having the highest subject occupancy rate as a distribution video image.

FIG. 4A illustrates a video image captured by a pan-tilt-zoom (PTZ) camera 120a in a case where a subject occupancy rate is smaller than or equal to a threshold, FIG. 4B illustrates a video image captured by a PTZ camera 120b in a case where a subject occupancy rate is smaller than or equal to the threshold, FIG. 4C illustrates a video image captured by a PTZ camera 120c in a case where a subject occupancy rate is smaller than or equal to the threshold, FIG. 4D illustrates a video image captured by a PTZ camera 120d in a case where a subject occupancy rate is smaller than or equal to the threshold, FIG. 4E illustrates a video image captured by the PTZ camera 120a in a case where a subject occupancy rate exceeds the threshold, FIG. 4F illustrates a video image captured by the PTZ camera 120b in a case where a subject occupancy rate exceeds the threshold, and FIG. 4G illustrates a video image captured by the PTZ camera 120c in a case where a subject occupancy rate exceeds the threshold.

FIGS. 4A through 4D illustrate video images captured by all of the four PTZ cameras 120a through 120d. FIG. 4A illustrates a video image captured by the PTZ camera 120a illustrated in FIG. 1, and FIG. 4B illustrates a video image captured by the PTZ camera 120b illustrated in FIG. 1. FIG. 4C illustrates a video image captured by the PTZ camera 120c illustrated in FIG. 1, and FIG. 4D illustrates a video image captured by the PTZ camera 120d illustrated in FIG. 1. Any of the video images in FIGS. 4A through 4D has a subject occupancy rate that is smaller than or equal to a threshold.

Since the subject occupancy rates in FIGS. 4A through 4D are ranked in descending order of FIG. 4C>FIG. 4B=FIG. 4D>FIG. 4A, the video image captured by the PTZ camera 120c is selected as a distribution video image.

Referring back to FIG. 3, if subject occupancy rates relative to the captured video data about all the PTZ cameras are not smaller than or equal to a threshold (NO in step S4), the processing proceeds to step S7. In step S7, from the video images captured by the PTZ cameras and having the subject occupancy rates exceeding the threshold, the switcher 140 selects a video image having a highest subject frontality as a distribution video image.

FIGS. 4E through 4G illustrate video images captured by the PTZ cameras 120a through 120c and having subject occupancy rates that exceed the threshold. FIG. 4E illustrates a video image captured by the PTZ camera 120a. FIG. 4F illustrates a video image captured by the PTZ camera 120b, and FIG. 4G illustrates a video image captured by the PTZ camera 120c.

Since the subject frontalities of FIGS. 4E through 4G are ranked in descending order of FIG. 4E>FIG. 4F>FIG. 4G, the video image captured by the PTZ camera 120a is selected as a distribution video image.

Referring back to FIG. 3, in step S12, the switcher 140 transmits the selected video image to the distribution server 150 via the captured video transmission unit 270, and distributes the selected video image via the distribution server 150.

Accordingly, the video image captured by the PTZ camera can be automatically selected and distributed.

The processing in step S3 of the flowchart illustrated in FIG. 3 has been described using a case in which the switcher 140 calculates a subject occupancy rate and a subject frontality. However, the processing in step S3 is not limited thereto. For example, the switcher 140 may calculate a subject occupancy rate in step S3, and may calculate a subject frontality if subject occupancy rates relative to the captured video data about all the PTZ cameras are not smaller than or equal to a threshold (NO in step S4). According to such a configuration, since a subject frontality is not calculated if subject occupancy rates relative to the captured video data about all the PTZ cameras are smaller than or equal to a threshold, a processing load of the switcher 140 can be reduced. Alternatively, if subject occupancy rates relative to the captured video data about all the PTZ cameras are not smaller than or equal to a threshold (NO in step S4), the switcher 140 may calculate a subject frontality in the captured video data having a subject occupancy rate that exceeds the threshold. Thus, a processing load of the switcher 140 can be reduced.

Alternatively, in step S5, a video image to be selected as a distribution video image may not be the video image having a highest subject occupancy rate. A video image the subject occupancy rate of which is relatively high may be selected as a distribution video image. For example, in a case where a subject is blocked by an object, a video image in which the subject is not blocked may be more suitable than the video image having a highest subject occupancy rate. That is, the switcher 140 can select a video image other than the video image having a highest subject occupancy rate, depending on a degree to which the subject is blocked by the blocking object.

Alternatively, in step S7, a video image to be selected as a distribution video image may not be the video image having a highest subject frontality. A video image the subject frontality of which is relatively high may be selected as a distribution video image. For example, in a case where a subject is blocked by an object, a video image in which a subject is not blocked may be more suitable than the video image having a highest subject frontality. That is, the switcher 140 can select a video image other than the video image having a highest subject frontality, depending on a degree to which the subject is blocked by the blocking object.

### Second Embodiment

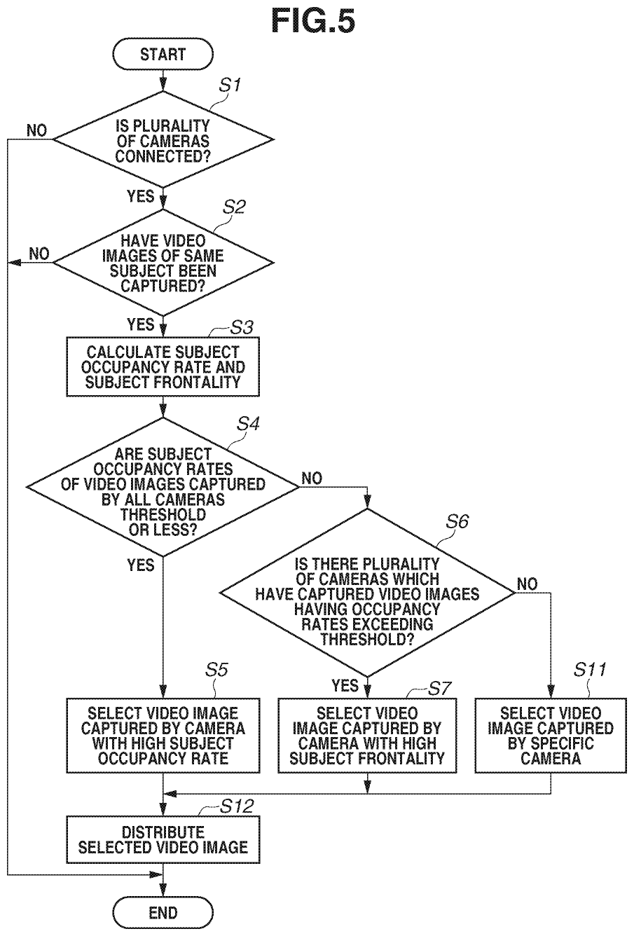

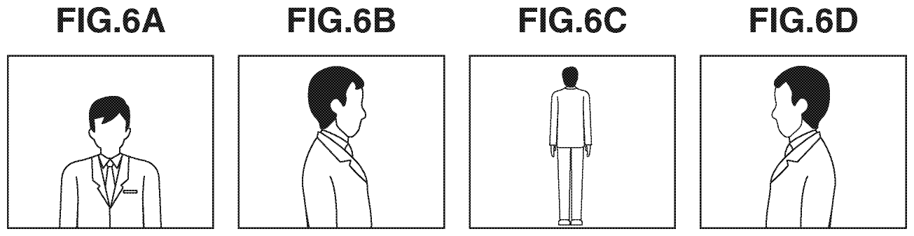

A remote camera system according to the second embodiment is similar to that of the first embodiment. Hereinafter, camera selection processing performed by a switcher 140 as an information processing apparatus according to the present embodiment is described with reference to FIGS. 5 and 6A through 6D. FIG. 5 is a flowchart illustrating the camera selection processing according to the present embodiment. FIGS. 6A through 6D are diagrams illustrating a method for selecting a camera according to the present embodiment. Since operations in steps S1 through S5, S7, and S12 in FIG. 5 are the same as those in the flowchart illustrated in FIG. 3 according to the first embodiment, descriptions of the same operations are omitted.

If subject occupancy rates relative to the captured video data about all the PTZ cameras are not smaller than or equal to a threshold (NO in step S4), the processing proceeds to step S6. In step S6, the switcher 140 as an information processing apparatus determines whether there is a plurality of cameras which have captured video images having subject occupancy rates that exceed the threshold. If there is a plurality of cameras which captured video images having subject occupancy rates that exceed the threshold (YES in step S6), the processing proceeds to step S7.

FIG. 6A illustrates a video image captured by a PTZ camera 120a, and FIG. 6B illustrates a video image captured by a PTZ camera 120b. FIG. 6C illustrates a video image captured by a PTZ camera 120c, and FIG. 6D illustrates a video image captured by a PTZ camera 120d. Out of these video images illustrated in FIGS. 6A through 6D, the video images illustrated in FIGS. 6A, 6B, and 6D have subject occupancy rates that are larger than or equal to the threshold. A relation of the subject frontalities of the video images illustrated in FIGS. 6A, 6B, and 6D is 6A>6B=6D. In this case, the switcher 140 as an information processing apparatus selects the video image captured by the PTZ camera 120a as a distribution video image.

Referring back to FIG. 5, if there is not a plurality of cameras which have captured video images having subject occupancy rates that exceed the threshold (NO in step S6), the processing proceeds to step S11. In step S11, since there is only one PTZ camera which has captured the video image having a subject occupancy rate that exceeds the threshold, the switcher 140 as an information processing apparatus selects the video image captured by such a PTZ camera as a distribution video image.

Accordingly, the video image captured by the PTZ camera can be automatically selected and distributed.

Although the embodiments of the present disclosure have been described, the present disclosure is not limited to these embodiments and various modifications and changes can be made within the scope of the present disclosure.

Aspects of the present disclosure can be achieved by a process in which a program for performing one or more functions of the above embodiments is supplied to a system or an apparatus via a network or a storage medium, and one or more processors in a computer of the system or the apparatus read and execute the program. Moreover, aspects of the present disclosure can be achieved by a circuit (e.g., application specific integrated circuit (ASIC)) for performing one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a selection burden on a user can be reduced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074997, filed Apr. 28, 2025, which is hereby incorporated by reference herein in its entirety.

What is claimed is:

1. An information processing apparatus comprising:
one or more memories storing instructions; and
one or more processors executing the instructions to:
receive video images captured by a plurality of cameras rotatable in at least two directions;
calculate an occupancy rate of a subject relative to the received video images;
calculate a frontality of the subject in the received video images;
select a video image from the received video images based on the occupancy rate in a case where the occupancy rates of all of the received video images are smaller than or equal to a threshold;
select a video image from video images having the occupancy rates exceeding a threshold based on the frontality in a case where the occupancy rate relative to any video image out of the received video images exceeds the threshold; and
output the selected video image.

2. The information processing apparatus according to claim 1, wherein the frontality is calculated based on the occupancy rate relative to any video image out of the received video images that exceeds the threshold.

3. The information processing apparatus according to claim 2, wherein the frontality is calculated with respect to only a video image having the occupancy rate exceeding the threshold.

4. The information processing apparatus according to claim 1, wherein, in a case where the occupancy rates of all of the received video images are smaller than or equal to the threshold, a video image having a highest occupancy rate is selected from the received video images.

5. The information processing apparatus according to claim 1, wherein, in a case where the occupancy rate relative to any video image out of the received video images exceeds the threshold, a video image having a highest frontality is selected from the video images having the occupancy rates exceeding the threshold.

6. The information processing apparatus according to claim 1, wherein the occupancy rate is a percentage of an area of a moving object that occupies the video image.

7. The information processing apparatus according to claim 1, wherein the frontality is a degree to which the subject faces front in the video image.

8. An information processing method comprising:
receiving video images captured by a plurality of cameras rotatable in at least two directions;
calculating an occupancy rate of a subject relative to the received video images;
calculating a frontality of the subject in the received video images;
selecting a video image from the received video images based on the occupancy rate in a case where the occupancy rates of all of the received video images are smaller than or equal to a threshold;
selecting a video image from video images having the occupancy rates exceeding a threshold based on the frontality in a case where the occupancy rate relative to any video image out of the received video images exceeds the threshold; and
outputting the selected video image.

9. A non-transitory computer-readable storage medium storing a program for causing a computer to execute an information processing method comprising:
receiving video images captured by a plurality of cameras rotatable in at least two directions;
calculating an occupancy rate of a subject relative to the received video images;
calculating a frontality of the subject in the received video images;
selecting a video image from the received video images based on the occupancy rate in a case where the occupancy rates of all of the received video images are smaller than or equal to a threshold;
selecting a video image from video images having the occupancy rates exceeding a threshold based on the frontality in a case where the occupancy rate relative to any video image out of the received video images exceeds the threshold; and
outputting the selected video image.
